(19) United States
(12) Patent Application Publication
(10) Pub. No.: US 2025/0389973 A1
(43) Pub. Date: Dec. 25, 2025

(54) EYEGLASS FRAME AND GLASSES

(71) Applicant: Quanta Computer Inc., Taoyuan City (TW)

(72) Inventors: Jyun-Jie CHEN, Taoyuan City (TW); Shih-Yun LEE, Taoyuan City (TW); Gwo-Chyuan CHEN, Taoyuan City (TW)

(73) Assignee: Quanta Computer Inc., Taoyuan City (TW)

(21) Appl. No.: 18/970,240

(22) Filed: Dec. 5, 2024

(30) Foreign Application Priority Data
Jun. 19, 2024 (TW) 113206427

(51) Int. Cl. G02C 5/12; G02C 1/04

(52) U.S. Cl. CPC G02C 5/128; G02C 1/04

(57) ABSTRACT

The present disclosure relates to an eyeglass frame, which includes a lens fixing portion, a connection portion, and a nosepiece. The lens fixing portion is configured to hold a lens. The connection portion is connected to the lens fixing portion. The nosepiece is connected to at least one of the lens fixing portion and the connection portion. The connection portion and the nosepiece respectively extend in different directions relative to the lens fixing portion.

### CROSS-REFERENCE TO RELATED APPLICATION

This application claims priority to Taiwan Application Serial Number 113206427, filed Jun. 19, 2024, which is herein incorporated by reference in its entirety.

### BACKGROUND

### Field of Invention

The present disclosure relates to an eyeglass frame and a pair of glasses. More particularly, the present disclosure relates to an eyeglass frame and a pair of glasses for augmented reality (AR).

### Description of Related Art

Augmented reality glasses (hereinafter referred to as “AR glasses”) can combine virtual elements with the real world. Users can view virtual images, information, or interaction elements and may merge them with their real-world view through AR glasses. AR glasses have been extensively applied in various fields, including entertainment, education, industry, and medical fields, as well as in our daily lives. However, for users with myopia, they currently still need to install and uninstall an additional myopia lens on AR glasses by assembling and disassembling, respectively, of the nosepiece. This process makes using these AR glasses inconvenient.

Therefore, there is a need for an eyeglass frame and a pair of glasses that can reduce the assembly and disassembly steps for users and can also provide a more comfortable wearing experience.

### SUMMARY

The disclosure provides an eyeglass frame comprising a lens fixing portion, a connection portion, and a nosepiece. The lens fixing portion is configured to fix a lens. The connection portion is connected to the lens fixing portion. The nosepiece is connected to at least one of the lens fixing portion and the connection portion. The connection portion and the nosepiece respectively extend in different directions relative to the lens fixing portion.

In some embodiments of the present disclosure, the lens fixing portion, the connection portion, and the nosepiece are made of metal.

In some embodiments of the present disclosure, the metal of the lens fixing portion, the connection portion, and the nosepiece has a thickness of less than 0.5 mm.

In some embodiments of the present disclosure, the nosepiece is covered with a layer of rubber.

In some embodiments of the present disclosure, the connection portion further includes a bridge portion and a connection arm that extended away from the bridge portion.

The disclosure further provides a pair of glasses comprising a temple arm, a connection section, and a spectacle frame portion. The connection section is connected to the temple arm. The spectacle frame portion is connected to the connection section and configured to hold another lens. The spectacle frame portion comprises a connection slot configured to interlock with the connection portion of the eyeglass frame as described herein.

The disclosure provides an eyeglass frame comprising a first spectacle frame portion, a connection portion, and a nosepiece. The first spectacle frame portion is configured to hold a lens. The first spectacle frame portion is a metal frame which surrounds and fixes the lens. The connection portion is connected to the first spectacle frame portion. The nosepiece is connected to one of the first spectacle frame portion and the connection portion. The connection portion and the nosepiece respectively extend in different directions relative to the first spectacle frame portion.

In some embodiments of the present disclosure, the connection portion and the nosepiece are made of a metal piece.

In some embodiments of the present disclosure, the metal piece has a thickness of less than 0.5 mm.

In some embodiments of the present disclosure, the nosepiece is covered with a layer of rubber.

In some embodiments of the present disclosure, the connection portion further includes a bridge arm and a connection arm that extended away from the bridge portion.

The disclosure further provides a pair of glasses comprising a temple arm, a connection section, and a second spectacle frame portion. The connection section is connected to the temple arm. The second spectacle frame portion is connected to the connection section and configured to hold another lens. The second spectacle frame portion comprises a connection slot configured to interlock with the connection portion of the eyeglass frame as described herein.

The disclosure provides an eyeglass frame comprising a first spectacle frame portion, a connection portion, and a nosepiece. The first spectacle frame portion is configured to hold a lens. The first spectacle frame portion is a plastic frame which surrounds and fixes the lens. The connection portion is connected to the first spectacle frame portion. The nosepiece is connected to one of the first spectacle frame portion and the connection portion. The connection portion and the nosepiece respectively extend in different directions relative to the first spectacle frame portion.

In some embodiments of the present disclosure, the connection portion and the nosepiece are made of plastic.

In some embodiments of the present disclosure, the eyeglass frame is a plastic monolithic structure.

In some embodiments of the present disclosure, the connection portion further includes a bridge portion and a connection arm that extended away from the bridge portion.

The disclosure further provides a pair of glasses comprising a temple arm, a connection section, and a second spectacle frame portion. The connection section is connected to the temple arm. The second spectacle frame portion is connected to the connection section and configured to hold another lens. The second spectacle frame portion comprises a connection slot configured to interlock with the connection portion of the eyeglass frame as described herein.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is an eyeglass frame according to one embodiment of this disclosure.

FIG. 2 is an eyeglass frame according to another embodiment of this disclosure.

FIG. 3 is an eyeglass frame according to another embodiment of this disclosure.

FIG. 4 is a pair of glasses according to one embodiment of this disclosure.

FIG. 5 is an eyeglass frame glasses combination according to one embodiment of this disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In order to help readers clearly understand the assembly relationship and orientation, a coordinate system is indicated in the drawings, including a first axis A1, a second axis A2, and a third axis A3.

In recent years, AR glasses have been extensively applied in various fields, including entertainment, education, industry, and medical fields, as well as in our daily lives. The market demand for AR glasses has been steadily growing. To enhance the wearing experience, more emphasis is placed on lightweight and comfortable design when making improvement to AR glasses.

For users with myopia, when using the AR glasses they would need to install an additional myopia lens on these AR glasses. This usually requires assembling and disassembling the nosepiece to install and uninstall, respectively, the additional myopia lens, which causes inconvenience for the users. Moreover, the addition of the myopia lens increases the weight of AR glasses and causes discomfort while the AR glasses are being worn.

In order to provide a more comfortable wearing experience, the present disclosure offers an eyeglass frame and a pair of glasses that can reduce assembly and disassembly steps for the users, which enhances comfort and efficiently address the discomfort issues users encounter while wearing AR glasses.

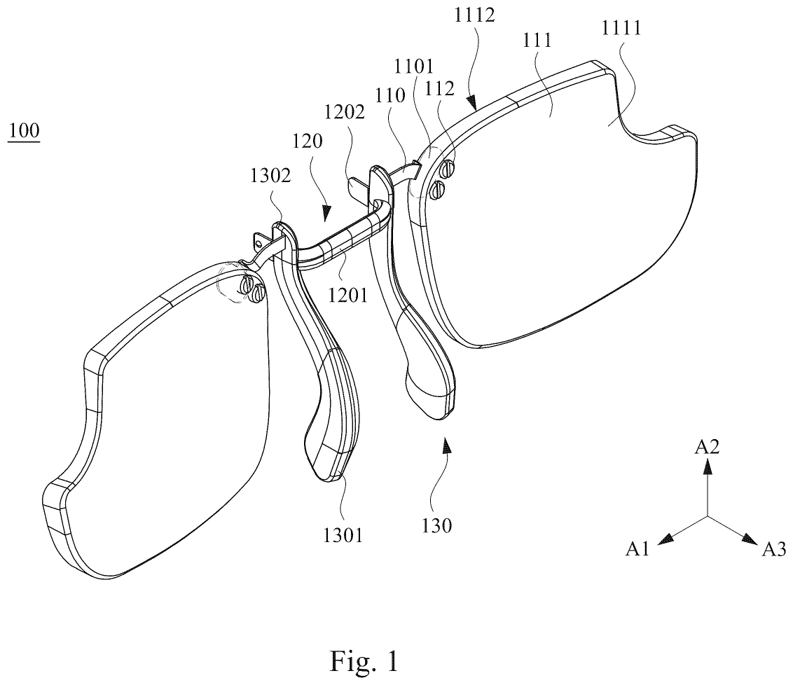

Referring to FIG. 1, FIG. 1 is an eyeglass frame 100 according to one embodiment of this disclosure. In FIG. 1, the eyeglass frame 100 includes a lens fixing portion 110, a connection portion 120, and a nosepiece 130. The lens fixing portion 110 is configured to fix a lens 111. The connection portion 120 is connected to the lens fixing portion 110. The nosepiece 130 is connected between the lens fixing portion 110 and the connection portion 120. In some embodiments, the nosepiece 130 may only connect one of the lens fixing portion 110 and the connection portion 120. The connection portion 120 and the nosepiece 130 respectively extend in different directions relative to the lens fixing portion 110.

In some embodiments, the lens fixing portion 110 has a fixed portion 1101. The lens 111 has a first surface 1111 and a second surface 1112. The first surface 1111 is near the user's eyes, while the second surface 1112 is away from the user's eyes. In some embodiments, the lens fixing portion 110 is fixed to the lens 111 by extending the fixed portion 1101 to the second surface 1112 and used a locking component 112 from the first surface 1111 to secure the lens 111. In some embodiments, the locking component 112 is a screw, which penetrates the lens 111 to lock it to the fixed portion 1101. However, the present disclosure is not limited to this.

In some embodiments, the connection portion 120 comprises a bridge portion 1201 and a connection arm 1202 that extended away from the bridge portion 1201. More particularly, the connection portion 120 has two connection arms 1202 that extended away from the first surface 1111 along the third axis A3, and a bridge portion 1201 connected to the connection arms 1202.

In some embodiments, the nosepiece 130 has a contact portion 1301 which extended away from the connection portion 120 along the second axis A2 and a connection portion 1302 is connected to the connection portion 120 and/or the lens fixing portion 110. The contact portion 1301 can touch the user's nose. In FIG. 1, the nosepiece 130 is connected to the lens fixing portion 110 on one side of the connection portion 1302, and to the connection portion 120 on the other side of the connection portion 1302.

In some embodiments, the lens fixing portion 110, the connection portion 120, and the nosepiece 130 are made of metal. However, the present disclosure is not limited to this. In some embodiments, the metal of the lens fixing portion 110, the connection portion 120, and the nosepiece 130 has a thickness of less than 0.5 mm, or a thickness of 0.4 mm or 0.3 mm. Reducing the metal piece's thickness can achieve the purpose of lightweight design, thereby reducing the burden on the user.

In some embodiments, the bridge portion 1201 of the connection portion 120 and the nosepiece 130 are covered with a layer of rubber. However, the present disclosure is not limited to this. The user can adjust the nosepiece 130 due to the good ductility of the metal, allowing it to conform to the shape of the user's nose and ensuring the stability of the eyeglass frame 100 while it is being worn. Moreover, the rubber material has soft, skin-friendly properties, which can enhance comfort when it comes in contact with the skin, thereby increasing the user's overall comfort while wearing the eyeglass frame 100.

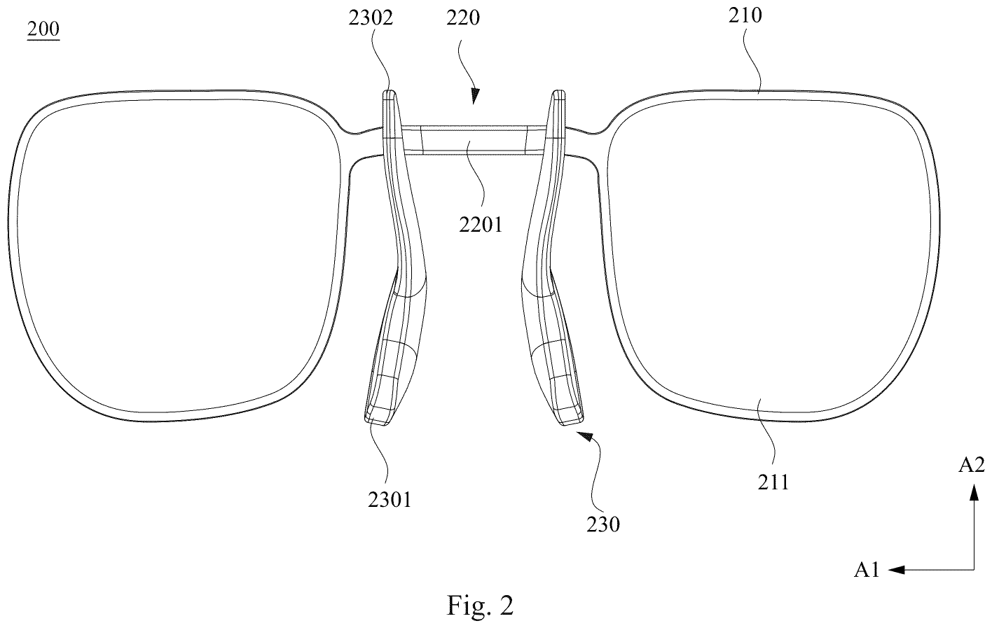

Referring to FIG. 2, FIG. 2 is an eyeglass frame 200 according to another embodiment of this disclosure. In FIG. 2, the eyeglass frame 200 includes a first spectacle frame portion 210, a connection portion 220, and a nosepiece 230. The first spectacle frame portion 210 is configured to hold a lens 211. The first spectacle frame portion 210 is a metal frame which surrounds and fixes sides of the lens 211. The connection portion 220 is connected to the first spectacle frame portion 210. The nosepiece 230 is connected to one of the first spectacle frame portion 210 and the connection portion 220. The connection portion 220 and the nosepiece 230 respectively extend in different directions relative to the first spectacle frame portion 210.

In some embodiments, the eyeglass frame 200 has the same structure as the eyeglass frame 100. The connection portion 220 comprises a bridge portion 2201 and a connection arm (not shown in the drawings) that extended away from the bridge portion 2201. More particularly, the connection portion 220 has two connection arms (not shown in the drawings) that extended away from the connection portion 220 along the third axis A3, and a bridge portion 2201 connected to the connection arms (not shown in the drawings).

In some embodiments, the nosepiece 230 has a contact portion 2301 which extended away from the connection portion 220 along the second axis A2 and a connection portion 2302 connected to the connection portion 220 and/or the first spectacle frame portion 210. The contact portion 2301 can touch the user's nose. In FIG. 2, the nosepiece 230 is connected to the first spectacle frame portion 210 on one side of the connection portion 2302, and to the connection portion 220 on the other side of the connection portion 2302.

In some embodiments, the connection portion 220 and the nosepiece 230 are made of metal. The metal of the connection portion 220 and the nosepiece 230 has a thickness of less than 0.5 mm, or a thickness of 0.4 mm or 0.3 mm. However, the present disclosure is not limited to this. In some embodiments, the connection portion 220 and the nosepiece 230 are covered with a layer of rubber.

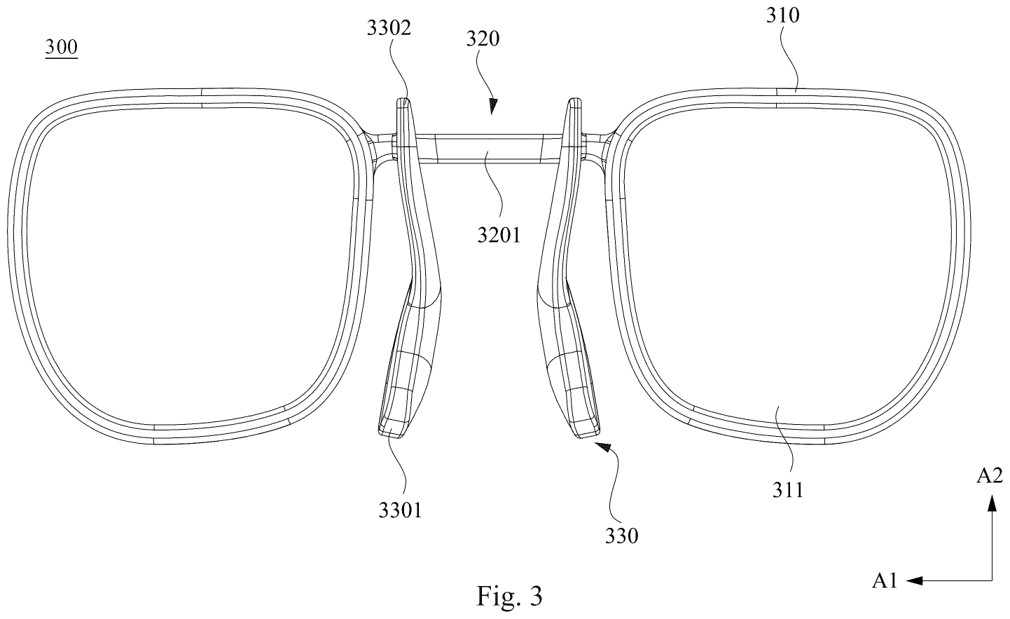

Referring to FIG. 3, FIG. 3 is an eyeglass frame 300 according to another embodiment of this disclosure. In FIG. 3, the eyeglass frame 300 including a first spectacle frame portion 310, a connection portion 320, and a nosepiece 330. The first spectacle frame portion 310 is configured to hold a lens 311. The first spectacle frame portion 310 is a plastic frame which surrounds and fixes sides of the lens 311. The connection portion 320 is connected to the first spectacle frame portion 310. The nosepiece 330 is connected to one of the first spectacle frame portion 310 and the connection portion 320. The connection portion 320 and the nosepiece 330 respectively extend in different directions relative to the first spectacle frame portion 310.

In some embodiments, the eyeglass frame 300 has the same structure as the eyeglass frame 100. The connection portion 320 comprises a bridge portion 3201 and a connection arm (not shown in the drawings) that extended away from the bridge portion 3201. More particularly, the connection portion 320 has two connection arms (not shown in the drawings) that extended away from the connection portion 320 along the third axis A3, and a bridge portion 3201 connected to the connection arms (not shown in the drawings).

In some embodiments, the nosepiece 330 has a contact portion 3301 which extended away from the connection portion 320 along the second axis A2 and a connection portion 3302 connected to the connection portion 320 and/or the first spectacle frame portion 310. The contact portion 3301 can touch the user's nose. In FIG. 3, the nosepiece 330 is connected to the first spectacle frame portion 310 on one side of the connection portion 3302, and to the connection portion 320 on the other side of the connection portion 3302.

In some embodiments, the connection portion 320 and the nosepiece 330 are made of plastic. In some embodiments, the eyeglass frame 300 is a plastic monolithic structure. However, the present disclosure is not limited to this. In some embodiments, the eyeglass frame 300 is covered with a layer of rubber.

As described herein, the present disclosure provides three different kinds of eyeglass frames that can satisfy the requests and styles of various users, which include the rimless eyeglass frame 100, which shows a fashionable and minimalist style; the full metal eyeglass frame 200, shows a classic and fashionable style; and the full plastic eyeglass frame 300, shows a lively and relaxed style.

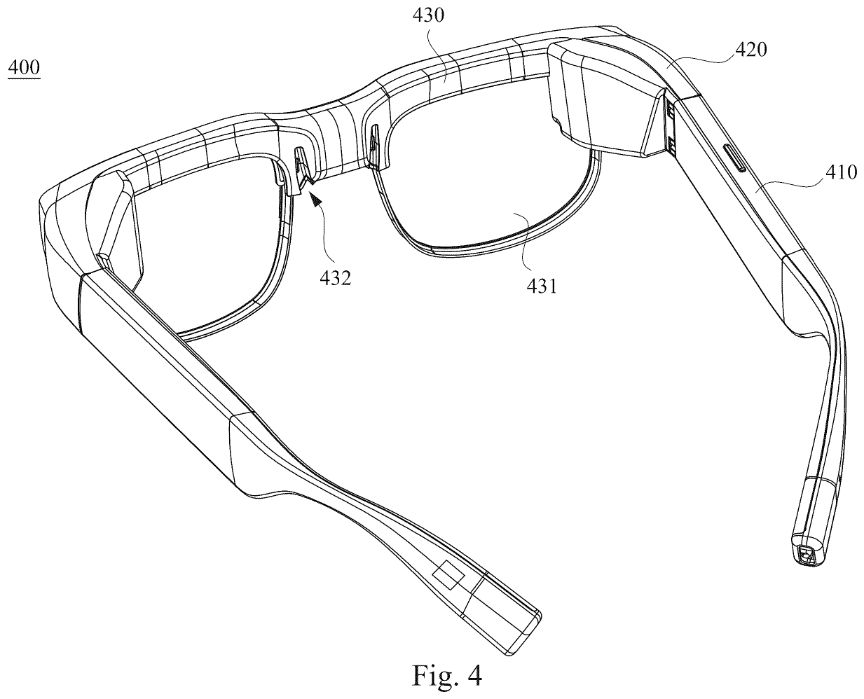

Referring to FIG. 4, FIG. 4 is a pair of glasses 400 according to another embodiment of this disclosure. In FIG. 4, the pair of glasses 400 includes a temple arm 410, a connection section 420, and a spectacle frame portion 430. The connection section 420 is connected to the temple arm 410. The spectacle frame portion 430 is connected to the connection section 420 and configured to hold lens 431. The spectacle frame portion 430 includes a connection slot 432, which is configured to interlock with the connection portion of the eyeglass frame as described herein.

In some embodiments, the glasses 400 are AR glasses. The user without myopia only needs to install the original nosepiece (not shown in the drawings) into the connection slot 432 of the glasses 400, and then the glasses 400 can be used immediately. For users with myopia, the design of the connection slot 432 can provide a quick and convenient way to install the eyeglass frame with myopia lens.

In some embodiments, the lens 431 is different from the lens 111, the lens 211, and the lens 311 as described herein. In some embodiments, the lens 111, the lens 211, and the lens 311 are myopia lenses for eyesight correcting, and the lens 431 is a lens forming images to the user with an optical module for AR glasses.

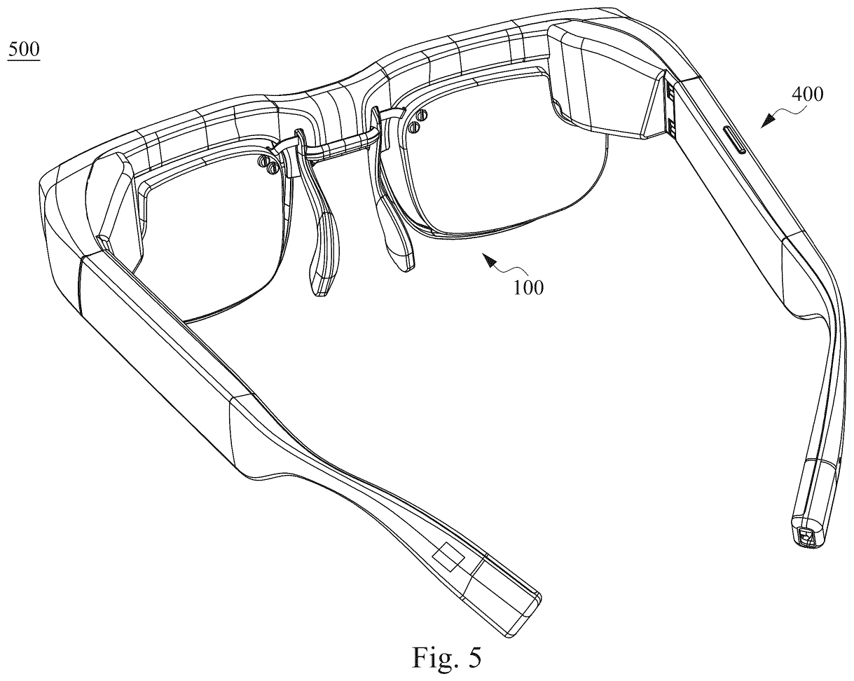

Referring to FIG. 5, FIG. 5 is an eyeglass frame glasses combination 500 according to another embodiment of this disclosure. Please refer to FIGS. 1 to 4 simultaneously. In FIG. 5, the user only needs to gently pull out the original nosepiece (not shown in the drawings) of the glasses 400 and install the connection arms 1202 of the eyeglass frame 100 into the connection slot 432 of the glasses 400, and then the combination of the eyeglass frame glasses combination 500 is complete. The user can easily install the eyeglass frame 100 on the glasses 400 without complicated steps to address the myopia issue. Therefore, the user can enjoy the wearing experience of AR glasses combined with the myopia lens. This improves the usability of AR glasses.

As described herein, the present disclosure provides an eyeglass frame and a pair of glasses to improve the comfort level and the user experience while wearing the AR glasses. The eyeglass frame of the present disclosure adopts a one-piece design and pairs with the AR glasses having a connection slot, which not only simplifies the process of lens assembly and disassembly for the user, but also making the installation quicker and more convenient. Due to the lightweight design of the eyeglass frame with myopia lenses, it also does not add any burden to the user. Moreover, the eyeglass frame becomes more comfortable to wear due to the rubber cover design, which alleviates discomfort from prolonged wearing of the eyeglass frames. Therefore, whether for extended reading, computer use, or outdoor activities, the eyeglass frame and glasses of the present disclosure can provide users with long-lasting comfort, allowing them to focus on their daily life activities and work without any discomfort or interference from wearing glasses.

The eyeglass frame and glasses of the present disclosure offer users multiple options. When the user has no myopia issues, the glasses can be used alone for an AR experience. However, for users with refractive problems such as myopia or hyperopia, different styles of eyeglass frames can be paired with the AR glasses, not only enhancing wearing comfort but also providing a variety of aesthetic styles.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An eyeglass frame, comprising:
a lens fixing portion configured to fix a lens;
a connection portion connected to the lens fixing portion; and
a nosepiece connected to at least one of the lens fixing portion and the connection portion;
wherein the connection portion and the nosepiece respectively extend in different directions relative to the lens fixing portion.

2. The eyeglass frame of claim 1, wherein the lens fixing portion, the connection portion, and the nosepiece are made of a metal.

3. The eyeglass frame of claim 2, wherein the metal has a thickness of less than 0.5 mm.

4. The eyeglass frame of claim 1, wherein the nosepiece is covered with a layer of rubber.

5. The eyeglass frame of claim 1, wherein the connection portion further comprises a bridge portion and a connection arm that extended away from the bridge portion.

6. A pair of glasses, comprising:
a temple arm;
a connection section connected to the temple arm; and
a spectacle frame portion connected to the connection section and configured to hold another lens, wherein the spectacle frame portion comprises a connection slot configured to interlock with the connection portion of the eyeglass frame of claim 1.

7. An eyeglass frame, comprising:
a first spectacle frame portion configured to hold a lens, wherein the first spectacle frame portion is made of metal and surrounds and fixes the lens;
a connection portion connected to the first spectacle frame portion; and
a nosepiece connected to one of the first spectacle frame portion and the connection portion;
wherein the connection portion and the nosepiece respectively extend in different directions relative to the first spectacle frame portion.

8. The eyeglass frame of claim 7, wherein the connection portion and the nosepiece are made of a metal.

9. The eyeglass frame of claim 7, wherein the metal has a thickness of less than 0.5 mm.

10. The eyeglass frame of claim 7, wherein the nosepiece is covered with a layer of rubber.

11. The eyeglass frame of claim 7, wherein the connection portion further comprises a bridge portion and a connection arm that extended away from the bridge portion.

12. A pair of glasses, comprising:
a temple arm;
a connection section connected to the temple arm; and
a second spectacle frame portion connected to the connection section and configured to hold another lens, wherein the second spectacle frame portion comprises a connection slot configured to interlock with the connection portion of the eyeglass frame of claim 7.

13. A eyeglass frame, comprising:
a first spectacle frame portion configured to hold a lens, wherein the first spectacle frame portion is made of plastic and surrounds and fixes the lens;
a connection portion connected to the first spectacle frame portion; and
a nosepiece connected to one of the first spectacle frame portion and the connection portion;
wherein the connection portion and the nosepiece respectively extend in different directions relative to the first spectacle frame portion.

14. The eyeglass frame of claim 13, wherein the connection portion and the nosepiece are made of a plastic.

15. The eyeglass frame of claim 13, wherein the eyeglass frame is a plastic monolithic structure.

16. The eyeglass frame of claim 13, wherein the connection portion further comprises a bridge portion and a connection arm that extended away from the bridge portion.

17. A pair of glasses, comprising:
a temple arm;
a connection section connected to the temple arm; and
a second spectacle frame portion connected to the connection section and configured to hold another lens, wherein the second spectacle frame portion comprises a connection slot configured to interlock with the connection portion of the eyeglass frame of claim 13.
